(19) United States
(12) Patent Application Publication
(10) Pub. No.: US 2006/0159807 A1
(43) Pub. Date: Jul. 20, 2006

(54) Container assemblies with releasable locking feature

(76) Inventors: Thomas J. Hayes, McHenry, IL (US); Scott D. Brown, Winthrop Harbor, IL (US); Paul L. Rodriguez, Barrington, IL (US)

Correspondence Address: John C. Gatz;JENKENS & GILCHRIST, A PROFESSIONAL CORPORATION, 225 W. Washington. Ste. 2600, Chicago, IL, 60606-3418, US

(21) Appl. No.: 11/255,314

(22) Filed: Oct. 21, 2005

Related U.S. Application Data
(63) Continuation-in-part of application No. 10/840,974, filed on May 7, 2004.
Application No. 10/840,974 is a continuation of application No. 10/277,303, filed on Oct. 22, 2002, now Pat. No. 6,886,704.

(51) Int. Cl. A23B 7/148

(52) U.S. Cl. 426/106

(57) ABSTRACT

A container assembly comprises first and second containers. The first container includes a first body portion and a first rim. The first rim has a first plurality of ribs projecting generally upwardly therefrom such that first spaces are formed between adjacent ribs. The first rim has a generally convex shape. The second container includes a second body portion and a second rim. The second rim has a second plurality of ribs projecting generally downwardly therefrom such that second spaces are formed between adjacent ribs. The second rim has a generally concave shape. The first and second rims have shapes that correspond with each other when locked. The first and second containers are adapted to be releasably lockable by fitting the second plurality of ribs into respective ones of the first plurality of ribs and fitting the first spaces into respective ones of the second spaces.

### RELATED APPLICATION

The present invention is a continuation-in-part of application Ser. No. 10/840,974 entitled “Containers and Container Assemblies with Releasable Locking Feature”, which is a continuation application of application Ser. No. 10/277,303 entitled “Containers and Container Assemblies with Releasable Locking Feature” that was filed on Oct. 22, 2002 and issued as U.S. Pat. No. 6,886,704. Both of these applications are incorporated by reference in its entirety.

### FIELD OF INVENTION

The present invention relates generally to container assemblies. More particularly, the present invention relates to releasably lockable container assemblies.

### BACKGROUND OF THE INVENTION

The use of inexpensive polymeric, paper or metal packaging containers has become popular, especially for preparing and serving various food products. Polymeric, paper and metal containers generally have been used for heating the food product(s) disposed therein. Container assemblies typically comprise a cover or lid and a base.

It would be desirable to have a container assembly that would be easy for the customer to close and open. It would also be desirable to provide a container assembly that is releasably lockable and prevents or inhibits material, such as liquid, from leaving the container.

### SUMMARY OF THE INVENTION

According to one embodiment, a container assembly comprises a first container and a second container. The first container includes a first continuous body portion and a first rim. The first rim encompasses and projects laterally outwardly from the first body portion. The first rim has a first plurality of ribs projecting generally upwardly therefrom such that first spaces are formed between adjacent ribs. The first rim has a generally convex shape. The second container includes a second continuous body portion and a second rim. The second rim encompasses and projects laterally outwardly from the second body portion. The second rim has a second plurality of ribs projecting generally downwardly therefrom such that second spaces are formed between adjacent ribs. The second rim has a generally concave shape. The first rim and the second rim have shapes that correspond with each other when being releasably lockable to each other. The first container and the second container are adapted to be releasably lockable to each other by fitting the second plurality of downwardly-projecting ribs into respective ones of the first plurality of upwardly-projecting ribs and fitting the first spaces into respective ones of the second spaces.

According to one method, a container assembly is formed by providing a first container that includes a first continuous body portion and a first rim. The first rim encompasses and projects laterally outwardly from the first body portion. The first rim has a first plurality of ribs projecting generally upwardly therefrom such that first spaces are formed between adjacent ribs. The first rim has a generally convex shape. A second container is provided that includes a second continuous body portion and a second rim. The second rim encompasses and projects laterally outwardly from the second body portion. The second rim has a second plurality of ribs projecting generally downwardly therefrom such that second spaces are formed between adjacent ribs. The second rim has a generally concave shape. One of the first container and the second container is flipped such that the first container and second container are generally aligned, the first and second rims are next to each other, and the first and second rims correspond with each other such that the first and second rims are either both in a generally concave orientation or a generally convex orientation. The second plurality of downwardly-projecting ribs fits into respective ones of the first plurality of upwardly-projecting ribs and the first spaces fit into respective ones of the second spaces such that the first container and the second container are releasably lockable to each other.

According to another embodiment, a container assembly comprises a first container and a second container. The first container includes a first continuous body portion and a first rim. The first rim encompasses and projects laterally outwardly from the first body portion. The first rim has a first plurality of upwardly-projecting features with first spaces being formed between adjacent upwardly-projecting features. The first rim has a generally convex shape. The second container includes a second continuous body portion and a second rim. The second rim encompasses and projects laterally outwardly from the second body portion. The second rim has a second plurality of downwardly-projecting features with second spaces being formed between adjacent downwardly-projecting features. The second rim has a generally concave shape. The first container and the second container are adapted to be releasably lockable to each other by fitting the second plurality of downwardly-projecting features into respective ones of the first plurality of upwardly-projecting features and fitting the first spaces into respective ones of the second spaces.

According to a further embodiment, a container assembly comprises a first container and a second container. The first container includes a first continuous body portion and a first rim. The first rim encompasses and projects laterally outwardly from the first body portion. The first rim has a generally convex shape. The first rim has a first plurality of ribs projecting generally upwardly therefrom such that first spaces are formed between adjacent ribs. The first plurality of upwardly-projecting ribs creates a first pattern that is generally normal to the direction of the first rim. The first plurality of upwardly-projecting ribs has at least one undercut. The second container includes a second continuous body portion and a second rim. The second rim encompasses and projects laterally outwardly from the second body portion. The second rim has a generally concave shape. The second rim has a second plurality of ribs projecting generally downwardly therefrom such that second spaces are formed between adjacent ribs. The second plurality of downwardly-projecting ribs creates a second pattern that is generally normal to the direction of the second rim. The second plurality of downwardly-projecting ribs has at least one undercut. The first container and the second container are adapted to be releasably lockable to each other by fitting the second plurality of downwardly-projecting ribs into respective ones of the first plurality of upwardly-projecting ribs and fitting the first spaces into respective ones of the second spaces.

According to a further embodiment, a container assembly comprises a first container and a second container. The first container includes a first continuous body portion and a first rim. The first rim encompasses and projects laterally outwardly from the first body portion. The first rim has a first plurality of ribs projecting generally upwardly therefrom such that first spaces are formed between adjacent ribs. The first plurality of upwardly-projecting ribs creates a first pattern that is generally normal to the direction of the first rim. The second container includes a second continuous body portion and a second rim. The second rim encompasses and projects laterally outwardly from the second body portion. The second rim has a second plurality of ribs projecting generally downwardly therefrom such that second spaces are formed between adjacent ribs. The second plurality of downwardly-projecting ribs creates a second pattern that is generally normal to the direction of the second rim. The second container is shaped generally the same as the first container. The first container and the second container are adapted to be releasably lockable to each other by fitting the second plurality of downwardly-projecting ribs into respective ones of the first plurality of upwardly-projecting ribs and fitting the first spaces into respective ones of the second spaces.

According to another method, a container assembly is formed. A first container is provided that includes a first continuous body portion and a first rim. The first rim encompasses and projects laterally outwardly from the first body portion. The first rim has a first plurality of ribs projecting generally upwardly therefrom such that first spaces are formed between adjacent ribs. The first plurality of upwardly-projecting ribs creates a first pattern that is generally normal to the direction of the first rim. A second container is provided that includes a second continuous body portion and a second rim. The second rim encompasses and projects laterally outwardly from the second body portion. The second rim has a second plurality of ribs projecting generally downwardly therefrom such that second spaces are formed between adjacent ribs. The second plurality of downwardly-projecting ribs creates a second pattern that is generally normal to the direction of the second rim. The second container is shaped generally the same as the first container. One of the first container and the second container is flipped such that the first container and second container are generally aligned, and the first and second rims are next to each other. The second plurality of downwardly-projecting ribs is fit into respective ones of the first plurality of upwardly-projecting ribs and the first spaces are fit into respective ones of the second spaces such that the first container and the second container are releasably lockable to each other.

According to a yet another embodiment, a container assembly comprises a first container and a second container. The first container includes a first continuous body portion and a first rim. The first rim encompasses and projects laterally outwardly from the first body portion. The first rim has a first plurality of upwardly-projecting features with first spaces being formed between adjacent upwardly-projecting features. The first plurality of upwardly-projecting features creates a first pattern that is generally normal to the direction of the first rim. The second container includes a second continuous body portion and a second rim. The second rim encompasses and projects laterally outwardly from the second body portion. The second rim has a second plurality of downwardly-projecting features with second spaces being formed between adjacent downwardly-projecting features. The second plurality of downwardly-projecting features creates a second pattern that is generally normal to the direction of the second rim. The second container is shaped generally the same as the first container. The first container and the second container are adapted to be releasably lockable to each other by fitting the second plurality of downwardly-projecting features into respective ones of the first plurality of upwardly-projecting features and fitting the first spaces into respective ones of the second spaces.

### BRIEF DESCRIPTION OF THE DRAWINGS

FIG. 1a is a side view of a first container to be used in one embodiment of the invention.

FIG. 1b is a top view of the first container of FIG. 1a.

FIG. 1c is an enlarged top perspective view of a portion of the first container of FIG. 1a.

FIG. 1d is an enlarged view of area labeled FIG. 1d in FIG. 1c;

FIG. 1e is an outline of the periphery of the first container of FIG. 1a.

FIG. 2a is a side view of a second container to be used in one embodiment of the invention.

FIG. 2b is a top view of the second container of FIG. 2a.

FIG. 2c is an enlarged top perspective view of a portion of the second container of FIG. 2a.

FIG. 2d is an enlarged bottom perspective view of area labeled FIG. 2d in FIG. 2c;

FIG. 2e is an outline of the periphery of the second container of FIG. 2a.

FIG. 3a is a side view of a container assembly using the first container of FIG. 1a and the second container of FIG. 2a.

FIG. 3b is an outline of the peripheries of the first and second containers used to form the container assembly of FIG. 3a.

FIG. 3c is an enlarged cross-sectional view depicting the engagement between the ribs of the first and second containers.

FIG. 4 is an outline of the periphery of the first container according to another embodiment.

FIG. 5a is a side view of a first container to be used in another embodiment of the invention.

FIG. 5b is a top view of the first container of FIG. 5a.

FIG. 5c is a top view of the generally circular region FIG. 5c of FIG. 5a depicting two adjacent projecting ribs.

FIG. 5d is a perspective view of the generally circular region FIG. 5c of FIG. 5a depicting two adjacent projecting ribs.

FIG. 6a is a side view of a second container to be used in another embodiment of the invention.

FIG. 6b is a top view of the second container of FIG. 6a.

FIG. 7a is a side view of a container assembly using the first container of FIG. 5a and the second container of FIG. 6a.

FIG. 7b is an outline of the peripheries of the first and second containers used to form the container assembly of FIG. 7a.

FIG. 8a is a side view of a first container to be used in a further embodiment of the invention.

FIG. 8b is a top view of the first container of FIG. 8a.

FIG. 8c is an enlarged top perspective view of a portion of the first container of FIG. 8a.

FIG. 8d is an enlarged view of area labeled FIG. 8d in FIG. 8c;

FIG. 8e is an outline of the periphery of the first container of FIG. 8a.

FIG. 9a is a side view of a container assembly using the first container of FIG. 8a and an identical container of FIG. 8a.

FIG. 9b is an outline of the peripheries of the first and second containers used to form the container assembly of FIG. 9a.

FIG. 9c is an enlarged cross-sectional view depicting the engagement between the ribs of the first and second containers.

While the invention is susceptible to various modifications and alternative forms, specific embodiments thereof have been shown by way of example in the drawing and will herein be described in detail. It should be understood, however, that it is not intended to limit the invention to the particular forms disclosed but, on the contrary, the intention is to cover all modifications, equivalents, and alternatives falling within the spirit and scope of the invention as defined by the appended claims.

### DESCRIPTION OF ILLUSTRATIVE EMBODIMENTS

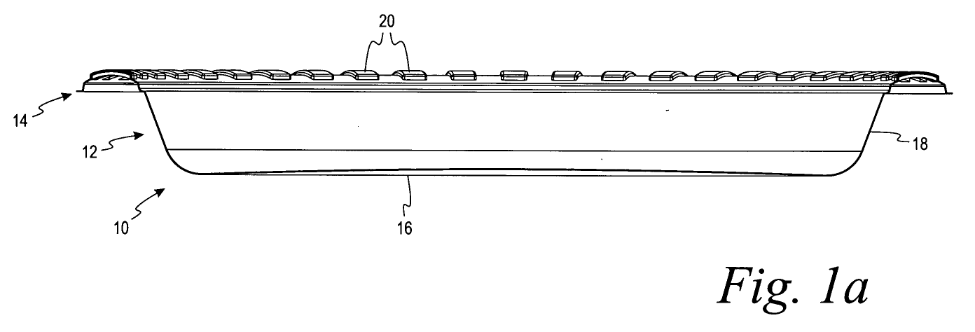

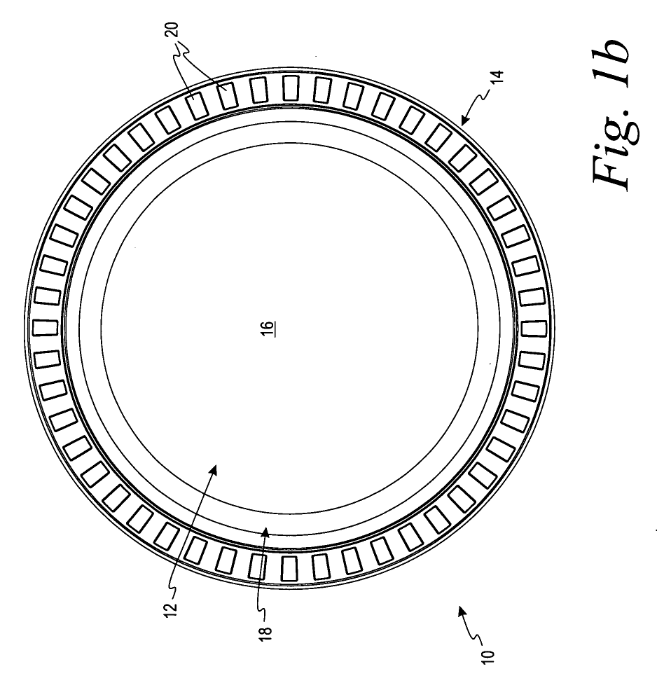

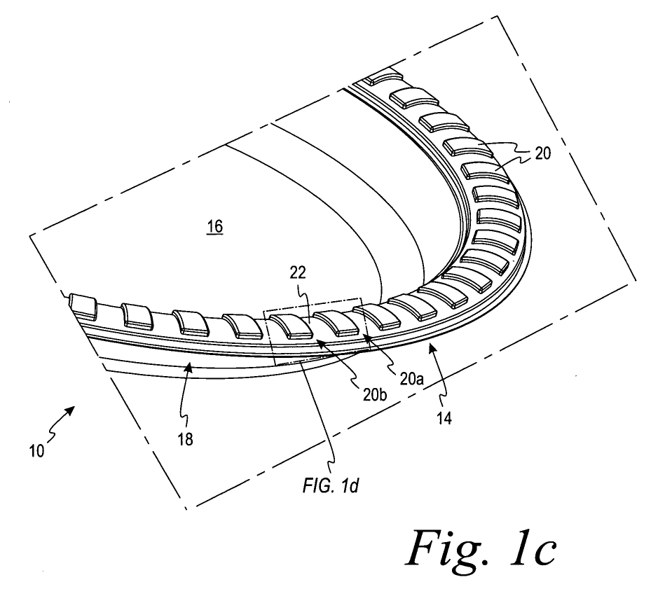

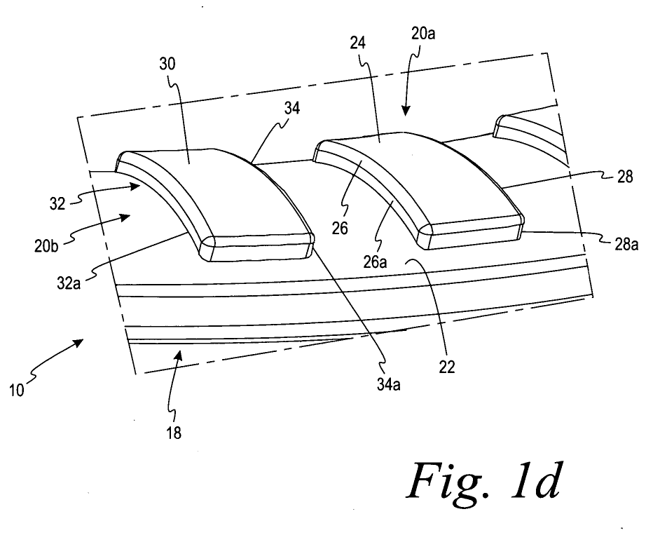

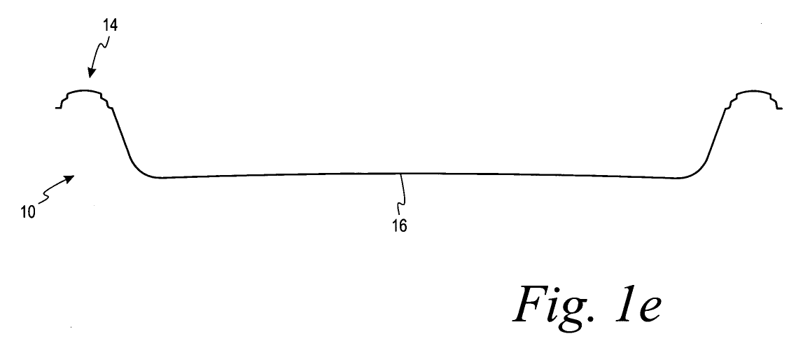

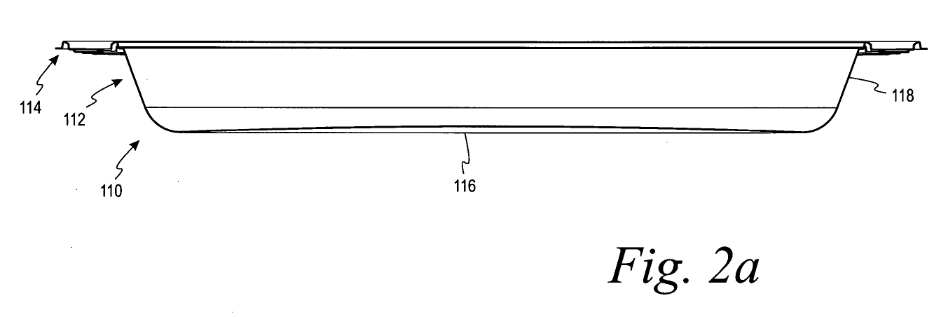

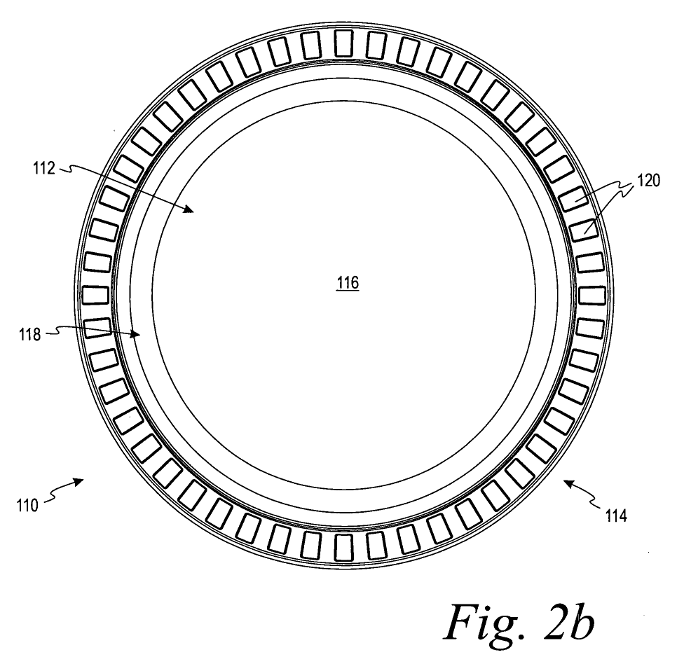

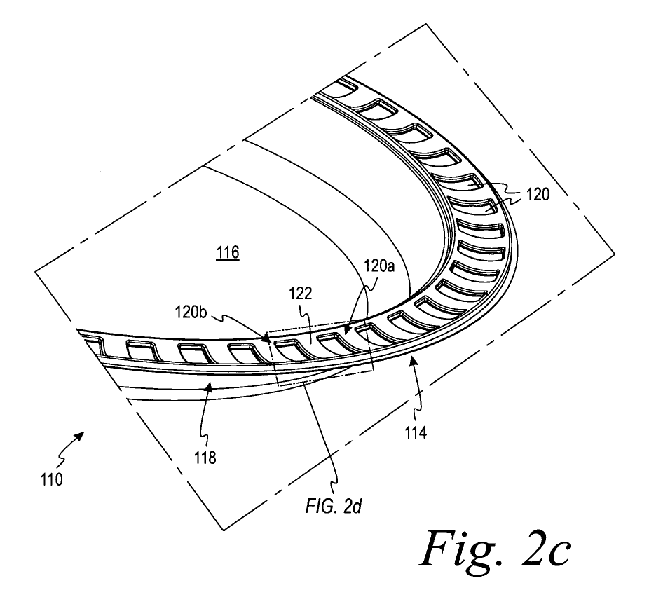

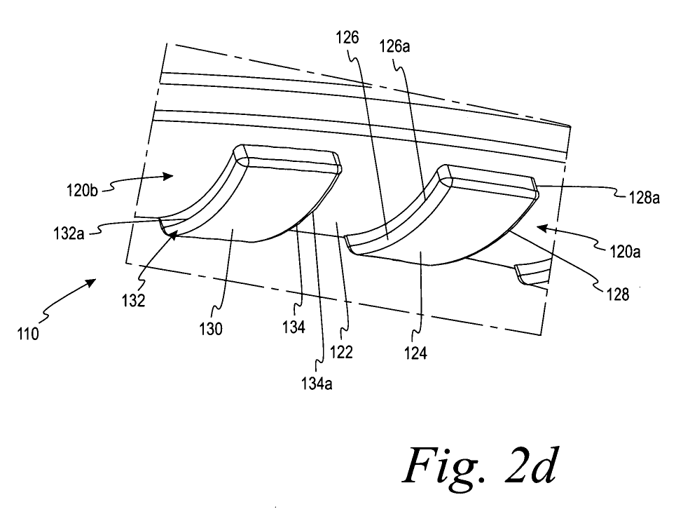

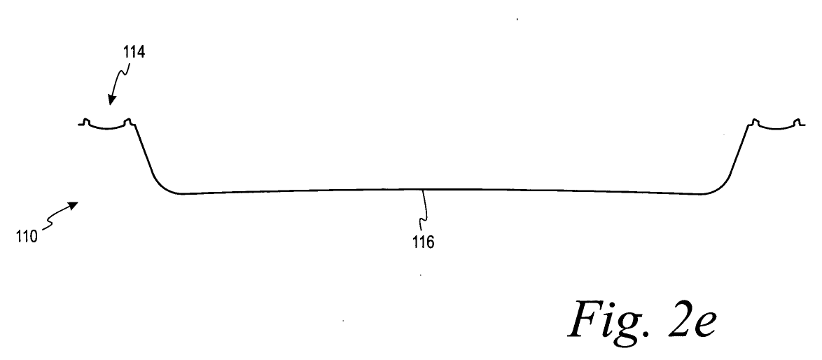

Referring to FIGS. 1a-e, 2a-e, a first container (e.g., plate 10) and a second container (e.g., plate 110) to be used in one embodiment of the present invention are shown. The plate 10 of FIGS. 1a-e is used with a second plate 110 of FIGS. 2a-e that may be substantially the same to the plate 10 to form a container assembly that is releasably lockable.

It is contemplated that other container assemblies may be formed besides those using plates. For example, container assemblies may be formed, but are not limited to, using plates, bowls, platters, tubs, single-serve and family-size containers, single-serve and family-size ovenware, and combinations thereof. One such combination is a bowl and a plate that forms a container assembly. The remainder of the application will discuss container assemblies with respect to plates although it is recognized by one of ordinary skill in the art that other container assemblies, such as those discussed above, may be formed.

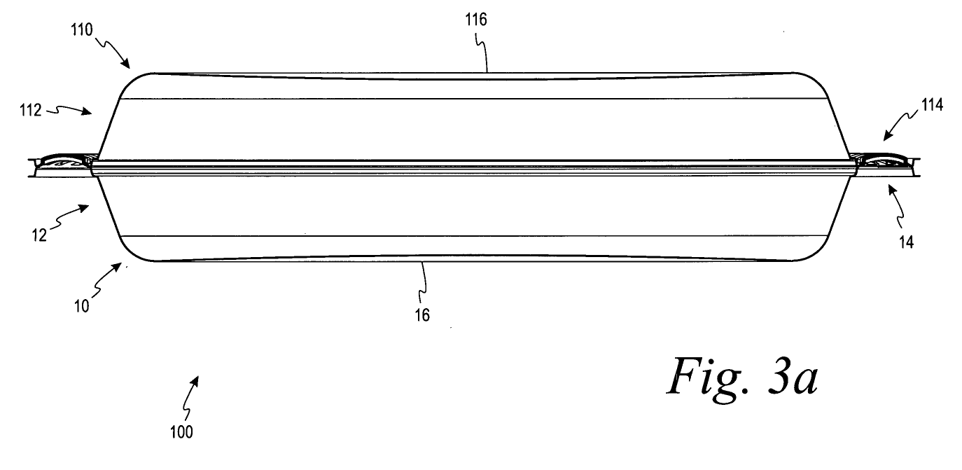

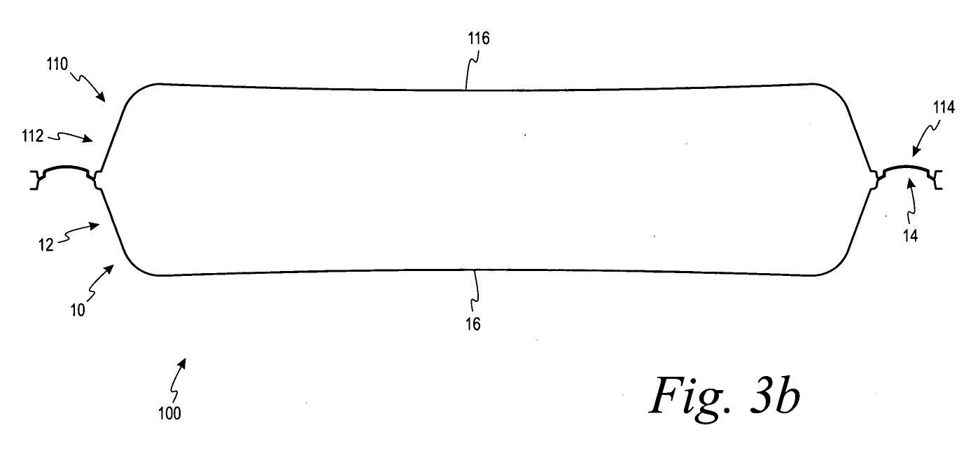

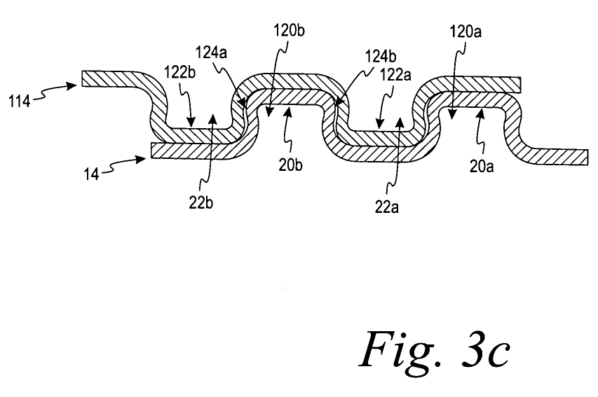

The height and shape of the container assembly may vary from that shown without departing from the scope of the invention. For example, the container assembly of FIGS. 3a, 3b as will be discussed, are depicted as being generally circular. It is contemplated that the container assemblies and containers for forming the container assemblies used herein may be other shapes such as rectangular, square, hexagonal, octagonal, other polygonal shapes, or oval.

The container assemblies of the present invention are typically used with respect to food, but may be used in other applications such as with medical applications, cosmetics or other items. Food container assemblies may be used for serving, storing, preparing and/or re-heating the food.

Referring back to FIGS. 1a-e, the container 10 includes a continuous body portion 12 and a continuous rim 14 encompassing and projecting laterally outwardly from the body portion 12. As shown in FIGS. 1a, 1e, the rim 14 has a generally convex shape. Referring back to FIGS. 1a-e, the body portion 12 includes a bottom 16 and a continuous sidewall 18 encompassing and projecting upwardly and outwardly from the bottom 16. It is contemplated that the sidewall may project only upwardly from the bottom 16 or even project upwardly and inwardly from the bottom 16. It is also contemplated that the rim may not be continuous, although it is preferred to be continuous.

Referring specifically to FIGS. 1a-d, the continuous rim 14 includes a plurality of ribs 20 that projects generally upwardly therefrom. The plurality of ribs 20 is spaced around the general periphery of the container 10 and assists in forming a releasably lockable container assembly. The orientation of the plurality of ribs 20 creates a pattern that is generally normal to the direction of the rim 14. More specifically, the orientation of the plurality of ribs 20 may create a pattern that is normal to the direction of the rim 14. In a radial configuration with a pattern that is normal to the direction of the rim, each of the plurality of ribs 20, if extended inwardly, would pass through the general center of the plate.

The plurality of ribs 20, however, may be formed in different patterns than shown in FIGS. 1a-d with respect to the rim 14 (e.g., diagonally). It may be desirable to form the plurality of ribs 20 in a decorative pattern for aesthetic reasons. Such a decorative feature may assist in “hiding” or disguising the releasable lockable feature in the container 10. As shown in FIG. 1b, the container 10 has exactly 48 ribs formed in the continuous rim 14. It is contemplated that the number of ribs may vary from that shown in FIG. 1b. For example, a container may have from about 3 to about 10 ribs. A container may have greater than about 20 or about 40 ribs, and may even have up to or greater than about 120 ribs. The desired number of ribs formed on the container will often vary depending on factors such as the size or shape of the container assembly, the material(s) type and thicknesses of the container assembly, and the desired holding strength of the container assembly. The desired holding strength depends on factors such as the weight of item(s) placed in the container assembly and its perceived usage.

Turning specifically to FIGS. 1c, 1d, the plurality of ribs 20 is shown in greater detail. FIGS. 1c, 1d depict a first rib 20a and a second rib 20b with a space 22 being formed therebetween. The first rib 20a of FIG. 1d comprises a generally flat surface 24 that bridges two sidewalls 26, 28. The first rib 20a is shown as being generally perpendicular to the plane of the remainder of the continuous rim 14. More specifically, the rib may be perpendicular to the plane of the remainder of the rim. The sidewalls 26, 28 are spaced apart from each other and are shown as being generally perpendicular to the plane of the remainder of the rim 14. The sidewalls 26, 28, however, do not necessarily have to be generally perpendicular or perpendicular to the remainder of the rim 14.

Similarly, second rib 20b of FIG. 1d comprises a generally flat surface 30 that bridges two sidewalls 32, 34. The second rib 20b is also shown as being generally perpendicular to the plane of the remainder of the rim 14. The sidewalls 32, 34 are spaced apart from each other and are shown as being generally perpendicular to the plane of the remainder of the rim 14.

To provide an improved locked container assembly, at least one of the rib sidewalls may have an undercut. Such an optional undercut formed in the rib sidewall engages a similar undercut in a corresponding rib sidewall of a second container when the container assembly is formed. For example, in FIG. 1d, optional undercuts 26a, 28a are formed in respective sidewalls 26, 28. The size and shape of the undercut will often vary depending on factors such as the size or shape of the container assembly, the material(s) type and thicknesses of the container assembly, and the desired holding strength of the container assembly. The desired holding strength may depend on factors such as the weight of item(s) placed in the container assembly and its perceived usage.

The number of undercuts formed in the rib sidewalls, if any, depends on factors such as the desired leak-resistant, the type of closure mechanism, manufacturability of the container assemblies, and the material(s) type and thicknesses used in forming the container assemblies. For example, if the container assemblies are made of a first material that has a higher coefficient of friction than a second material, then the container made of the first material will likely need less undercuts in its sidewalls than the same container made with the second material to have the same holding strength. The number of undercuts used also depends on the fitness of use of the container assembly, including the holding strength thereof.

It is contemplated that the ribs may have sidewalls with no undercuts or at least one undercut (e.g., first rib 20a with optional undercuts 26a, 28a in FIG. 1d). It is also contemplated that some ribs within the same container may have no undercuts, while other ribs may have one or more undercuts.

It is contemplated that the shape and size of the plurality of ribs 20 may vary from that shown in FIGS. 1c, 1d. It is preferred that the plurality of ribs be shaped and sized to minimize the stacking height of the containers used to form container assemblies. It is desirable to minimize the stacking height of the containers to (a) reduce transportation costs and packaging, and (b) provide space efficiency in retail and consumer settings. It is also desirable to maximize the holding strength of the container assembly. The desired holding strength is often a balance between making the container assembly easy for a consumer to open and close, while still preventing or inhibiting an inadvertent opening of the container assembly.

It is contemplated that the upwardly-projecting features may be shaped differently than the ribs shown in FIGS. 1c, 1d. For example, the upwardly-projecting features may be a plurality of generally round, generally oval, generally square, or generally polygonal features. It is contemplated that many shapes and sizes may be formed by the upwardly-projecting features used in the first container.

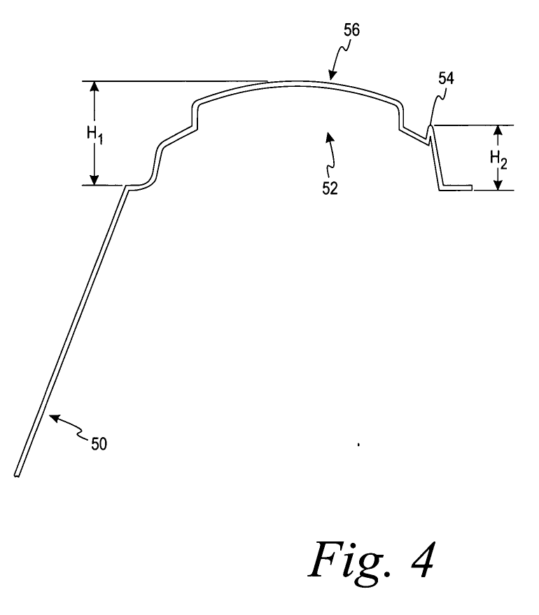

Referring to FIG. 4, a first container 50 includes a rim 52 in which the rim forms an optional seal feature 54 and a rib 56. The rim 52 is shown as being generally convex. In FIG. 4, the optional seal feature 54 is located outwardly from the rib 56 with respect to the center of the container 50. In other words, the optional seal feature 54 is located farther away from the center of the container 50 than the rib 56. The optional seal feature 54 in conjunction with a corresponding optional seal feature on a second container with a generally concave rim (not shown), along with the locked ribs of the container assembly, assist in preventing or inhibiting material from leaving or entering the container assembly. The optional seal feature is especially useful in preventing or inhibiting product leakage that may occur due to tolerances within the manufacturing process. To provide an efficient seal, the height H1 of the optional seal feature 54 should be at least one-half of the rib height H2.

The optional seal feature, however, may be located inwardly from the ribs such that the seal is formed nearer the center of the container assembly as compared to the releasably lockable ribs.

Referring back to FIGS. 2a-e, the container 110 includes a continuous body portion 112 and a continuous rim 114 encompassing and projecting laterally outwardly from the body portion 112. As shown in FIG. 2b, the rim 114 has a generally concave shape. The body portion 112 includes a bottom 116 and a continuous sidewall 118 encompassing and projecting upwardly and outwardly from the bottom 116. It is contemplated that the sidewall may project only upwardly from the bottom 116 or even project upwardly and inwardly from the bottom 116. It is also contemplated that the rim may not be continuous, although it is preferred to be continuous.

Referring specifically to FIGS. 2a-d, the continuous rim 114 includes a plurality of ribs 120 that projects generally downwardly therefrom. The plurality of ribs 120 is spaced around the general periphery of the container 110 and assists in forming a releasably lockable container assembly. The orientation of the plurality of ribs 120 creates a pattern that is generally normal to the direction of the rim 114. More specifically, the orientation of the plurality of ribs 120 may create a pattern that is normal to the direction of the rim 114. In a radial configuration with a pattern that is normal to the direction of the rim, each of the plurality of ribs 120, if extended inwardly, would pass through the general center of the plate.

The plurality of ribs 120, however, may be formed in different patterns than shown in FIGS. 2a-d with respect to the rim 114 (e.g., diagonally). It may be desirable to form the plurality of ribs 120 in a decorative pattern for aesthetic reasons. Such a decorative feature may assist in “hiding” or disguising the releasable lockable feature in the container 110. As shown in FIG. 2b, the container 110 has exactly 48 ribs formed in the continuous rim 114. It is contemplated that the number of ribs may vary from that shown in FIG. 2b. For example, a container may have from about 3 to about 10 ribs. A container may have greater than about 20 or about 40 ribs, and may even have up to or greater than about 120 ribs. The desired number of ribs formed on the container will often vary depending on factors such as the size or shape of the container assembly, the material(s) type and thicknesses of the container assembly, and the desired holding strength of the container assembly. The desired holding strength depends on factors such as the weight of item(s) placed in the container assembly and its perceived usage.

Turning specifically to FIGS. 2c, 2d, the plurality of ribs 120 is shown in greater detail. FIGS. 2c, 2d depict a first rib 120a and a second rib 120b with a space 122 being formed therebetween. The first rib 120a of FIG. 2d comprises a generally flat surface 124 that bridges two sidewalls 126, 128. The first rib 120a is shown as being generally perpendicular to the plane of the remainder of the continuous rim 114. More specifically, the rib may be perpendicular to the plane of the remainder of the rim. The sidewalls 126, 128 are spaced apart from each other and are shown as being generally perpendicular to the plane of the remainder of the rim 114. The sidewalls 126, 128, however, do not necessarily have to be generally perpendicular or perpendicular to the remainder of the rim 14.

Similarly, second rib 120b of FIG. 2d comprises a generally flat surface 130 that bridges two sidewalls 132, 134. The second rib 120b is also shown as being generally perpendicular to the plane of the remainder of the rim 114. The sidewalls 132, 134 are spaced apart from each other and are shown as being generally perpendicular to the plane of the remainder of the rim 114.

To provide an improved locked container assembly, at least one of the rib sidewalls may have an undercut. Such an optional undercut formed in the rib sidewall engages a similar undercut in a corresponding rib sidewall of a second container when the container assembly is formed. For example, in FIG. 2d, optional undercuts 126a, 128a are formed in respective sidewalls 126, 128. The size and shape of the undercut will often vary depending on factors such as the size or shape of the container assembly, the material(s) type and thicknesses of the container assembly, and the desired holding strength of the container assembly. The desired holding strength may depend on factors such as the weight of item(s) placed in the container assembly and, its perceived usage.

The number of undercuts formed in the rib sidewalls, if any, depends on factors such as the desired leak-resistant, the type of closure mechanism, manufacturability of the container assemblies, and the material(s) type and thicknesses used in forming the container assemblies. For example, if the container assemblies are made of a first material that has a higher coefficient of friction than a second material, then the container made of the first material will likely need less undercuts in its sidewalls than the same container made with the second material to have the same holding strength. The number of undercuts used also depends on the fitness of use of the container assembly, including the holding strength thereof.

It is contemplated that the ribs may have sidewalls with no undercuts or at least one undercut (e.g., first rib 120a with optional undercuts 126a, 128a in FIG. 2c). It is also contemplated that some ribs within the same container may have no undercuts, while other ribs may have one or more undercuts.

It is contemplated that the shape and size of the plurality of ribs 120 may vary from that shown in FIGS. 2c, 2d. It is preferred that the plurality of ribs be shaped and sized to minimize the stacking height of the containers used to form container assemblies. It is desirable to minimize the stacking height of the containers to (a) reduce transportation costs and packaging, and (b) provide space efficiency in retail and consumer settings. It is also desirable to maximize the holding strength of the container assembly. The desired holding strength is often a balance between making the container assembly easy for a consumer to open and close, while still preventing or inhibiting an inadvertent opening of the container assembly.

It is contemplated that the downwardly-projecting features may be shaped differently than the ribs shown in FIGS. 2c, 2d. For example, the downwardly-projecting features may be a plurality of round, oval, square, or polygonal features. It is contemplated that many shapes and sizes may be formed by the downwardly-projecting features used in the second container.

A container assembly 100 according to one embodiment of the present invention is depicted in FIGS. 3a, 3b. The container assembly 100 comprises the first container 10 and the second container 110.

According to one method, the second container 110 is flipped 180 degrees relative to the first container 10 such that the containers 10, 110 are generally aligned and the rims 14, 114 are adjacent to each other. This flipped position of container 110 relative to the container 10 is shown in FIG. 3a. To fit the ribs of the first container into a respective one of the ribs of the second container, the container 110 may have to be rotated slightly such that the ribs are aligned (i.e., the ribs and spaces are offset). It is desirable that the consumer can assemble the containers so as to form a container assembly of the present invention.

Referring to FIG. 3c, adjacent ribs 20a, 20b of the container 10 are fit into a respective one of adjacent ribs 120a, 120b of the container 110 and spaces 122a, 122b of the container 110 are fit into a respective one of spaces 22a, 22b such that the container assembly 100 is releasably lockable. To fit the ribs of the first container into a respective one of the ribs of the second container, the container 110 may have to be rotated slightly such that the ribs are aligned (i.e., the ribs and spaces are offset). FIG. 3c also depicts interference areas 124a, 124b formed between the respective ribs 20b, 120b.

The strength of this lockable closure is dependent on many variables such as the number of the projecting ribs, the height of those ribs, whether undercuts are included, the size of the contact areas, the clearance needed between spaces and ribs, and the material(s) type and thickness used in forming the container assemblies. To improve the lockability of the container assembly, as discussed above, an optional sealing feature may be added.

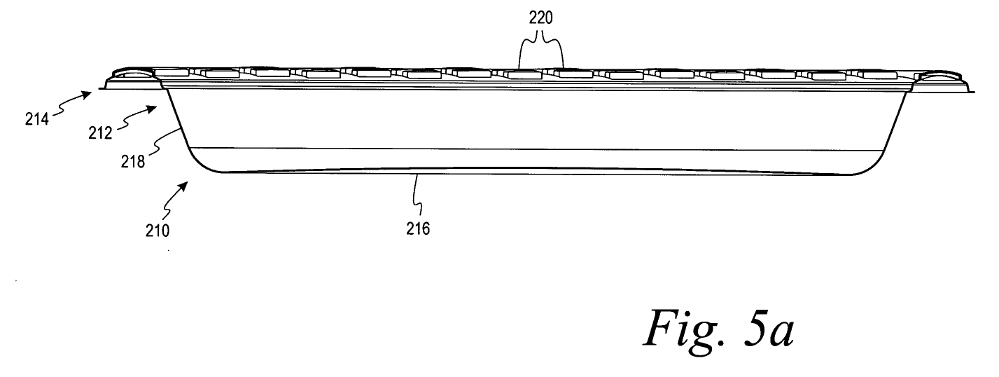

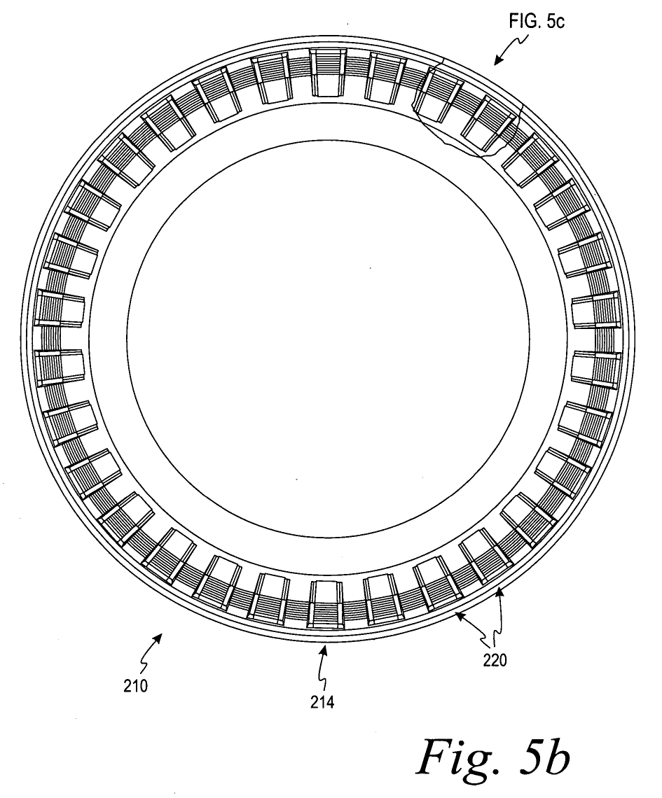

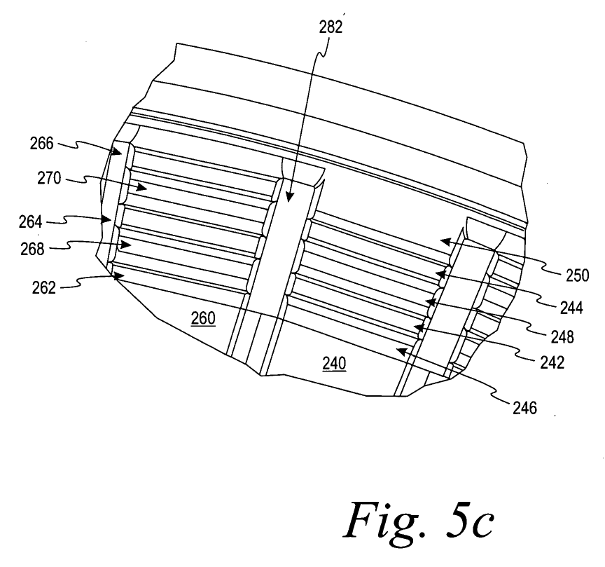

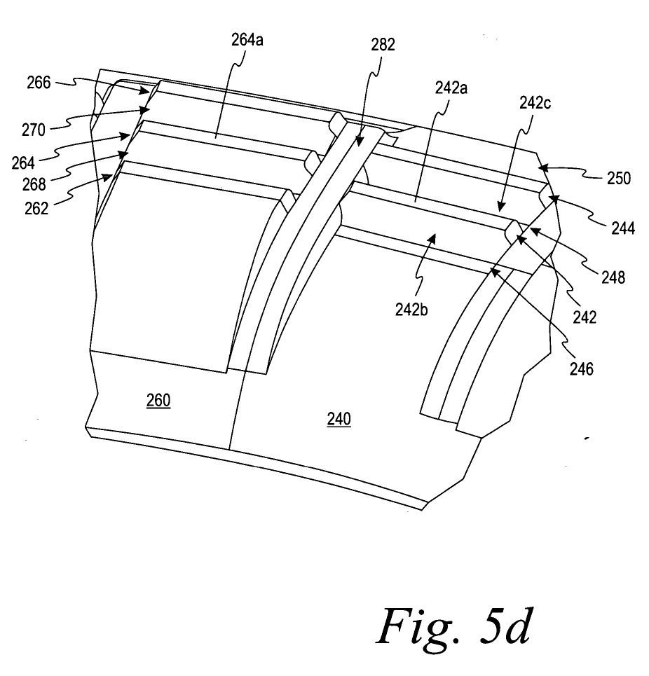

Referring to FIGS. 5a, 5b, a first container (e.g., plate 210) includes a continuous body portion 212 and a continuous rim 214 encompassing and projecting laterally outwardly from the body portion 212. As shown in FIG. 5a, the rim 214 has a generally convex shape. The body portion 212 includes a bottom 216 and a continuous sidewall 218 encompassing and projecting upwardly and outwardly from the bottom 216. It is contemplated that the sidewall may project only upwardly from the bottom 216 or even project upwardly and inwardly from the bottom 216. It is also contemplated that the rim may not be continuous, although it is preferred to be continuous.

Referring to FIGS. 5a-d, the continuous rim 214 includes a plurality of rib sets 220 that projects generally upwardly therefrom. The plurality of rib sets 220 is spaced around the general periphery of the container 210 and assists in forming a releasably lockable container assembly. The orientation of the plurality of rib sets 220 creates a pattern that is generally parallel or generally concentric with the general direction of the rim 214. In other words, each of the plurality of rib sets 220, if extended outwardly, would be no closer to the general center of the container 210. The plurality of rib sets 220 is in the opposite direction of the plurality of ribs 20 in FIGS. 1-3.

The plurality of rib sets 220, however, may be formed in different patterns than shown in FIG. 5b with respect to the rim 214 (e.g., diagonally). It may be desirable to form the plurality of rib sets 220 in a decorative pattern for aesthetic reasons. Such a decorative feature may assist in “hiding” or disguising the releasable lockable feature in the container 210.

The container 210 of FIG. 5b has exactly 30 sets of ribs formed in the continuous rim 214. As will be discussed in more detail below, each of the plurality of rib sets 220 has a first set of ribs on a raised portion and a second set of ribs on a recessed portion. It is contemplated that the number of rib sets may vary from that shown in FIG. 5b. For example, a container may have from about 2 to about 30 sets of ribs. A container may have greater than about 40 or about 80 sets of ribs, and may even have up to or greater than about 120 sets of ribs. The desired number of ribs formed on the container will often vary depending on factors such as the size or shape of the container assembly, the material(s) type and thicknesses of the container assembly, and the desired holding strength of the container assembly. The desired holding strength may depend on factors such as the weight of item(s) placed in the container assembly and its perceived usage.

Turning to FIGS. 5c, 5d, two adjacent sets of ribs are shown in greater detail. The number of ribs in a set varies in FIGS. 5c, 5d depending on whether the ribs are located in a recessed area or a raised area formed in the rim 214. For example, in FIGS. 5c, 5d, recessed area 240 has a first rib 242 and a second rib 244 with spaces 246, 248 and 250. Raised area 260 of FIGS. 5c, 5d, however, has a first rib 262, a second rib 264, and a third rib 266 with spaces 268, 270 therebetween.

Each of the ribs of FIG. 5c projects upwardly from the continuous rim 214. For example, the first rib 242 of FIG. 5d comprises a generally flat surface 242a that bridges two sidewalls 242b, 242c. The first rib 242 is shown as being generally perpendicular to the plane of the remainder of the continuous rim 214. The sidewalls 242b, 242c are spaced apart from each other and are shown as being generally perpendicular to the plane of the remainder of the rim 214. The sidewalls 242b, 242c, however, do not necessarily have to be generally perpendicular or perpendicular to the remainder of the rim 214.

To provide an improved locked container assembly, at least one of the rib sidewalls may have an optional undercut. As discussed above, such an undercut formed in the rib sidewall engages a similar undercut in the rib sidewall when the container assembly is formed. The size and shape of the undercut will often vary depending on factors such as the size or shape of the container assembly, the material(s) type and thicknesses of the container assembly, and the desired holding strength of the container assembly. The desired holding strength may depend on factors such as the weight of item(s) placed in the container assembly and its perceived usage.

As discussed above, the number of undercuts formed in the rib sidewalls, if any, depends on several factors. It is contemplated that the ribs may have sidewalls with no undercuts or at least one undercut. It is also contemplated that some ribs within the same container may have no undercuts, while other ribs have one or more undercuts.

The raised and recessed areas 240, 260 of FIG. 5d have a plurality of ribs with generally flat areas. For example, the rib 242 includes the top surface or generally flat area 242a. Similarly, the rib 264 includes a top surface or generally flat area 264a. To improve the sealability of the container assembly, the generally flat areas 264a, 242a may contact similar sized flat areas formed in respective ribs of a second container that forms the container assembly. As shown in FIG. 5d, a generally flat area 282 is formed between adjacent sets of ribs (i.e., the raised and recessed portions) to assist in releasably locking the container assembly. It is contemplated that this area of the ribs may be sized and shaped differently than shown in FIGS. 5c, 5d. It is contemplated that the numbers of ribs in a set of ribs may vary from that shown in FIGS. 5c, 5d (two ribs in the recessed areas and three ribs in the raised areas).

It is contemplated that the first container 210 may include shape and size of the plurality of ribs 220 may vary from that shown in FIGS. 5b-d. It is preferred that the plurality of ribs be shaped and sized to minimize the stacking height of the containers. It is desirable to minimize the stacking height of the containers to (a) reduce transportation costs and packaging, and (b) provide space efficiency in retail and consumer settings. It is also desirable to maximize the holding strength of the container assembly. The desired holding strength is often a balance between making the container assembly easy for a consumer to open and close, while still preventing or inhibiting an inadvertent opening of the container assembly.

It is contemplated that the first container 210 may include an optional seal feature formed on the rim 214. The optional seal feature may be located outwardly from the ribs 242, 244, 262, 264 and 266 of FIGS. 5c, 5d with respect to the center of the container 210. In other words, the optional seal feature may be located farther away from the center of the container 210 than the ribs. The optional seal feature in conjunction with a corresponding seal feature on another container, along with the locked ribs of the container assembly, assist in preventing or inhibiting material from leaving or entering the container assembly. The optional seal feature is especially useful in preventing or inhibiting product leakage that may occur due to tolerances within the manufacturing process. Such an optional seal feature may be formed similarly to the optional seal feature 54 in FIG. 4.

The optional seal feature, however, may be located inwardly from the ribs such that the seal is formed nearer the center of the container assembly as compared to the releasably lockable ribs.

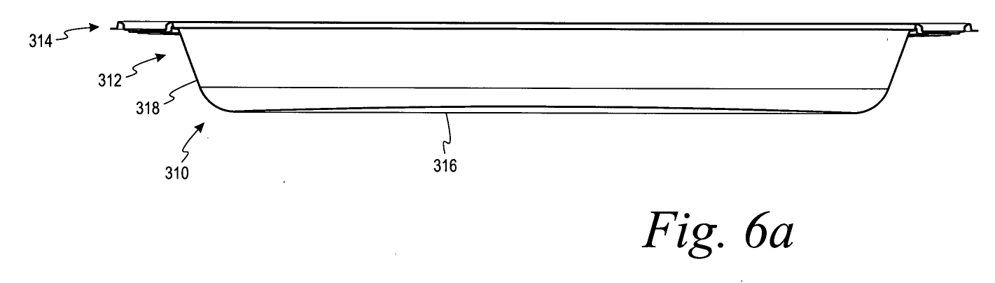

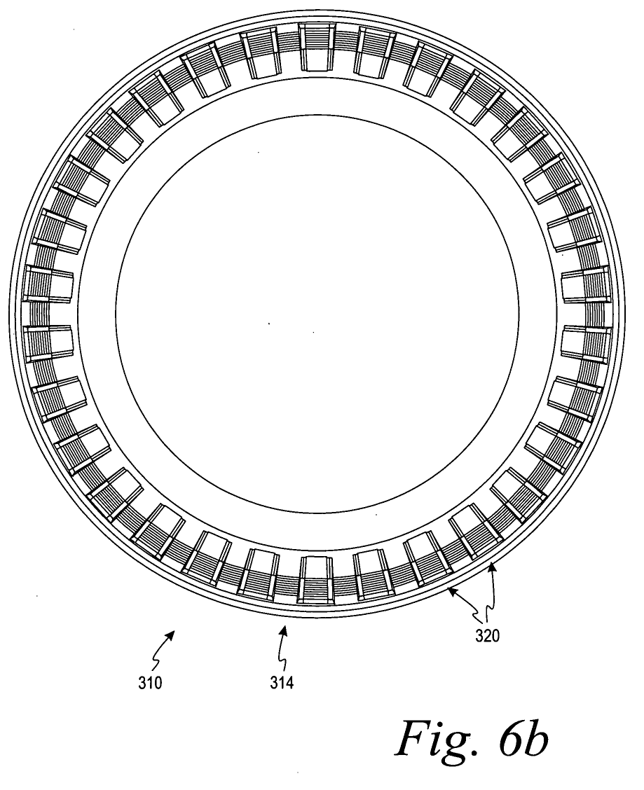

Turning to FIGS. 6a, 6b, the second container 310 includes a continuous body portion 312 and a continuous rim 314 that encompasses and projects laterally outwardly from the body portion 312. The continuous rim 314 has a generally concave shape. The body portion 312 includes a bottom 316 and a continuous sidewall 318 encompassing and projecting upwardly and outwardly from the bottom 316. It is contemplated that the sidewall may project only upwardly from the bottom 316 or even project upwardly and inwardly from the bottom 216. It is also contemplated that the rim may not be continuous, although it is preferred to be continuous. The second container 310 is the same as the first container 210 except that the continuous rim 214 of the first container has a generally convex shape, while the continuous rim 314 of the second container has a generally concave shape.

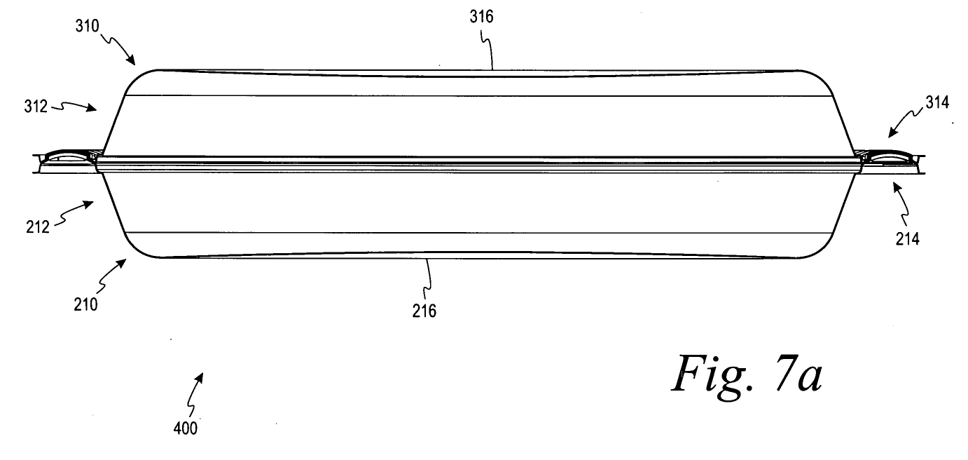

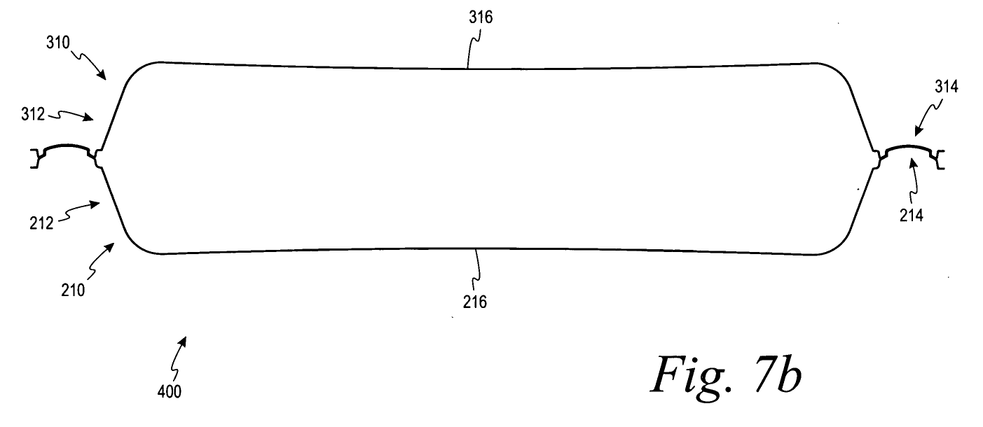

A container assembly 400 according to one embodiment of the present invention is depicted in FIGS. 7a, 7b. The container 400 comprises the first container 210 of FIGS. 5a-d and the second container 310 of FIGS. 6a, 6b. In one embodiment, the second container 310 is shaped substantially the same as the first container 210. As discussed above, the container assembly may be formed with different first and second containers than plates. For example, the container assembly may be formed using a bowl and a plate.

The container assembly 400 of FIGS. 7a, 7b may be formed according to one method by providing the first container 210 and the second container 310. As discussed above with container assembly 100, the second container 310 is flipped 180 degrees relative to the first container 210 such that the containers 210, 310 are generally aligned and the rims 214, 314 are adjacent to each other. This flipped position of the container 310 relative to the container 210 is shown in FIGS. 7a, 7b.

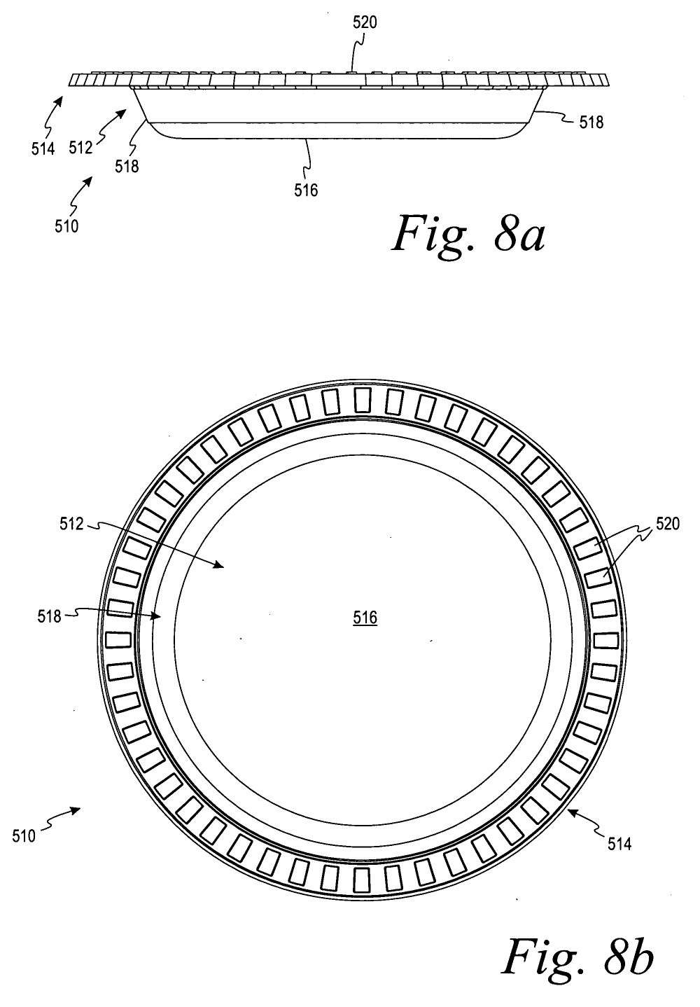

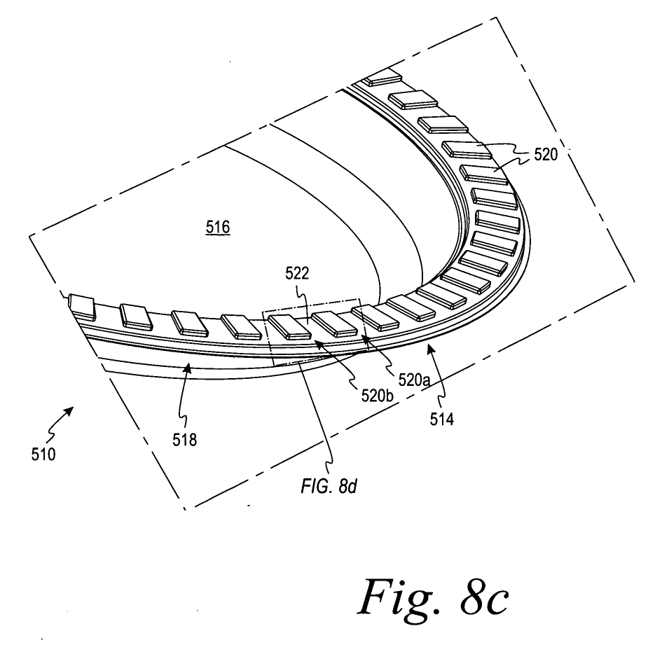

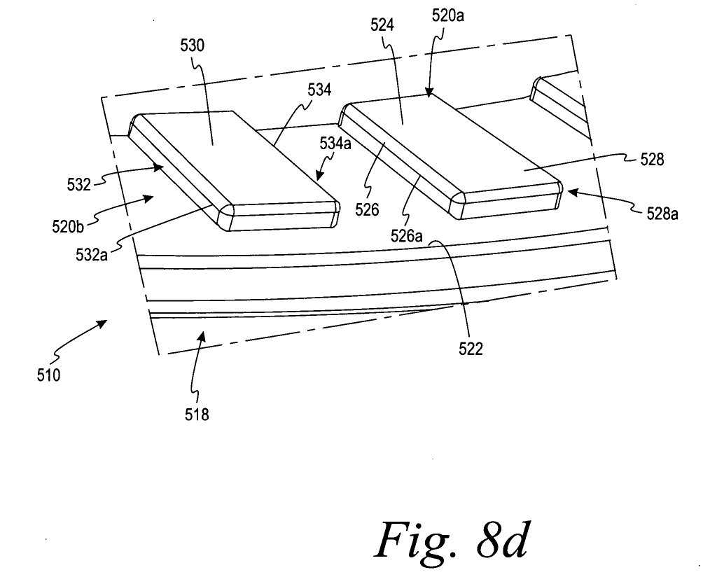

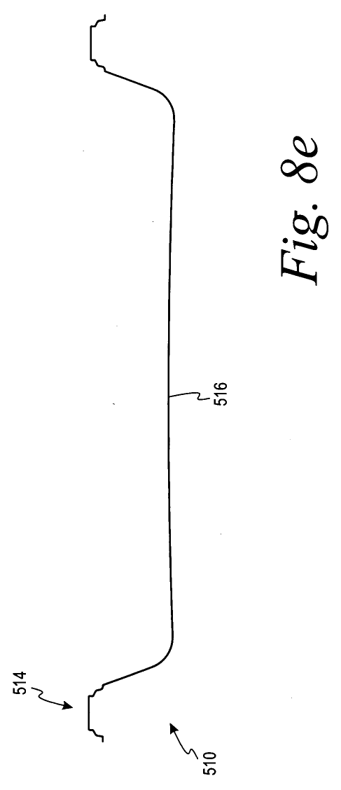

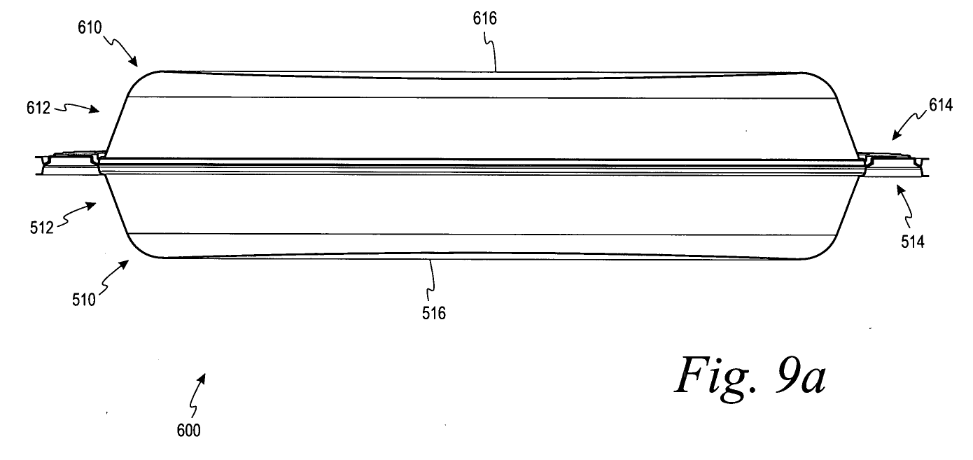

Referring to FIGS. 8a-e, 9a-c, a first container (e.g., plate 510) and a second identical container (e.g., plate 610) to be used in another embodiment of the present invention are shown. The plate 510 of FIGS. 8a-e is used with the second plate 610 to form a container assembly that is releasably lockable. As discussed above, it is contemplated that other container assemblies may be formed besides those using plates. It is also contemplated that the second container may be substantially identical to the first container. As discussed above, the height and shape of the container assembly may vary from that shown without departing from the scope of the invention.

Referring back to FIGS. 8a-e, the container 510 includes a continuous body portion 512 and a continuous rim 514 encompassing and projecting laterally outwardly from the body portion 512. As shown in FIGS. 8a, 8e, the rim 514 extends generally horizontally from the body portion 512. Referring back to FIGS. 8a-e, the body portion 512 includes a bottom 516 and a continuous sidewall 518 encompassing and projecting upwardly and outwardly from the bottom 516. It is contemplated that the sidewall may project only upwardly from the bottom 516 or even project upwardly and inwardly from the bottom 516. It is also contemplated that the rim may not be continuous, although it is preferred to be continuous.

Referring specifically to FIGS. 8a-d, the continuous rim 514 includes a plurality of ribs 520 that projects generally upwardly therefrom. The plurality of ribs 520 is spaced around the general periphery of the container 510 and assists in forming a releasably lockable container assembly. The orientation of the plurality of ribs 520 creates a pattern that is generally normal to the direction of the rim 514. More specifically, the orientation of the plurality of ribs 520 may create a pattern that is normal to the direction of the rim 514. In a radial configuration with a pattern that is normal to the direction of the rim, each of the plurality of ribs 520, if extended inwardly, would pass through the general center of the plate. As shown in FIG. 8b, the container 510 has exactly 48 ribs formed in the continuous rim 514. It is contemplated that the number of ribs may vary from that shown in FIG. 8b. For example, a container may have from about 3 to about 10 ribs. A container may have greater than about 20 or about 40 ribs, and may even have up to or greater than about 120 ribs.

Turning specifically to FIGS. 8c, 8d, the plurality of ribs 520 is shown in greater detail. FIGS. 8c, 8d depict a first rib 520a and a second rib 520b with a space 522 being formed therebetween. The first rib 520a of FIG. 8d comprises a generally flat surface 524 that bridges two sidewalls 526, 528. The first rib 520a is shown as being generally perpendicular to the plane of the remainder of the continuous rim 514. The sidewalls 526, 528 are spaced apart from each other and are shown as being generally perpendicular to the plane of the remainder of the rim 514. The sidewalls 526, 528, however, do not necessarily have to be generally perpendicular or perpendicular to the remainder of the rim 514. Similarly, second rib 520b of FIG. 8d comprises a generally flat surface 530 that bridges two sidewalls 532, 534.

To provide an improved locked container assembly, at least one of the rib sidewalls may have an undercut. Such an optional undercut formed in the rib sidewall engages a similar undercut in a rib sidewall of a second container when the container assembly is formed. For example, in FIG. 8d, optional undercuts 526a, 528a are formed in respective sidewalls 526, 528 and optional undercuts 532a, 534a are formed in respective sidewalls 532, 534. It is contemplated that the shape and size of the plurality of ribs 520 may vary from that shown in FIGS. 8c, 8d.

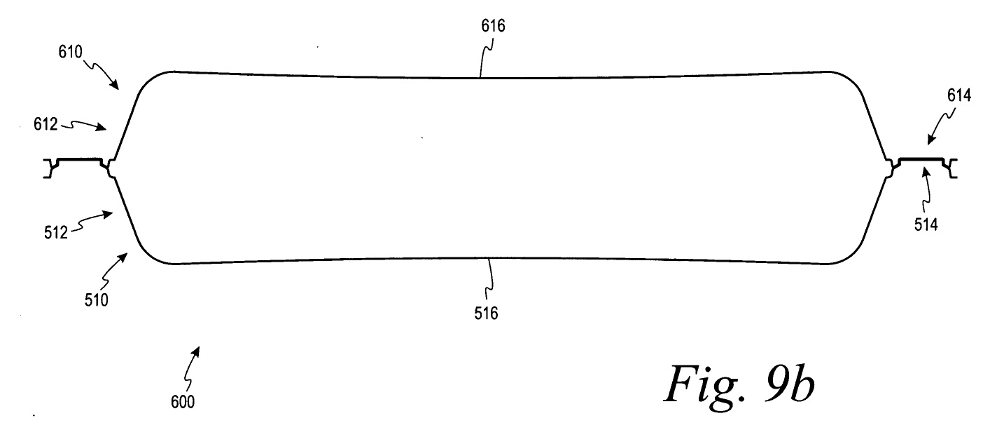

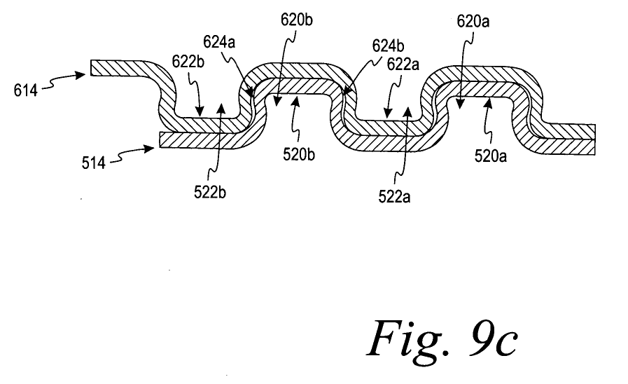

A container assembly 600 according to another embodiment of the present invention is depicted in FIGS. 9a, 9b. The container assembly 600 comprises the first container 510 and the second container 610. The second container 610 includes a continuous body portion 612, a continuous rim 614, a bottom 616 and ribs 620. The body portion 612, rim 614, bottom 616 and ribs 620 are the same as body portion 512, rim 514, bottom 516 and ribs 520, which are described above.

According to one method, the second container 610 is flipped 180 degrees relative to the first container 510 such that the containers 510, 610 are generally aligned and the rims 514, 614 are adjacent to each other. This flipped position of container 610 relative to the container 510 is shown in FIG. 9a. To fit the ribs of the first container into a respective one of the ribs of the second container, the container 610 may have to be rotated slightly such that the ribs are aligned (i.e., the ribs and spaces are offset). It is desirable that the consumer can assemble the containers so as to form a container assembly of the present invention.

Referring to FIG. 9c, adjacent ribs 520a, 520b of the container 510 are fit into a respective one of adjacent ribs 620a, 620b of the container 610 and spaces 622a, 622b of the container 610 are fit into a respective one of spaces 522a, 522b such that the container assembly 600 is releasably lockable. To fit the ribs of the first container into a respective one of the ribs of the second container, the container 610 may have to be rotated slightly such that the ribs are aligned (i.e., the ribs and spaces are offset). FIG. 9c also depicts interference areas 624a, 624b formed between the respective ribs 520b, 620b.

The container assemblies of the present invention are typically formed from polymeric materials, but may be formed from materials such as paper or metal. The polymeric container assemblies may be formed from polyolefins. The polymeric food container assemblies are typically formed from orientated polystyrene (OPS), polyethylene terephthalate (PET), polyvinyl chloride (PVC), polypropylene and combinations thereof. The containers assemblies may be made from a mineral-filled polymeric material such as, for example, talc or calcium carbonate-filled polyolefin. An example of paper that may be used in forming the container assemblies is paperboard or molded fiber. Paperboard and molded fiber typically have a sufficient coefficient of friction to maintain the first and second containers in a lockable position.

As discussed, the materials used in forming the container assembly may assist in releasably locking the container assembly. For example, the material(s) forming the container assembly may have a fairly tacky laminate on one side that corresponds with a fairly tacky laminate on the opposing side, resulting in a desirable releasably lockable container assembly.

It is contemplated that the containers used in forming the container assemblies may be made from different materials. It is contemplated that one of ordinary skill in the art will recognize that other polymers or combination of polymers may be used to form the containers.

The container assemblies of the present invention are typically disposable, but it is contemplated that they may be reused at a future time. The containers used in forming the container assemblies (e.g., containers 10, 110) are shown as including one compartment. It is contemplated that the containers may be formed of multiple compartments. Such containers are desirable for placing items (e.g., food items) in different compartments to prevent or inhibit commingling of items. For example, undesirable mixing of food items can corrupt the flavor and the consistency of the food items.

As discussed above, the container assemblies may be used with food items. A method of using such container assemblies includes placing the food and locking the containers to form a container assembly with food therein. The container assembly is then placed in a heating apparatus and heated. Typical heating apparatuses include microwaves and conventional ovens. The container assemblies may contain solid food products. The container assemblies may be used for storage in the refrigerator and/or the freezer.

The containers to be used in forming the container assemblies of the present invention may be formed using conventional thermoforming (e.g., by pressure, vacuum or the combination thereof), injection-molding processes, or rotational molding. According to one method of thermoforming, pellets of a polymeric resin and additives, if any, are added into an extruder. The pellets of the polymeric resin and additives, if any, are melted to form a blend. The blend is extruded through a die to form an extruded sheet. The extruded sheet is thermoformed to a desired shape of a container to be used in forming the container assembly.

The thickness of the container to be used in forming the container assemblies generally ranges from about 0.002 to about 0.15 inch, but is typically from about 0.005 to about 0.04 inch. The container assemblies may be opaque or a variety of colors or color combinations. The container assemblies typically have at least one transparent container if it is desired for the customer to ascertain the nature of the accommodated product and the condition thereof without having to open the container assembly.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A container assembly comprising:
a first container including a first continuous body portion and a first rim, the first rim encompassing and projecting laterally outwardly from the first body portion, the first rim having a first plurality of ribs projecting generally upwardly therefrom such that first spaces are formed between adjacent ribs, the first rim having a generally convex shape; and
a second container including a second continuous body portion and a second rim, the second rim encompassing and projecting laterally outwardly from the second body portion, the second rim having a second plurality of ribs projecting generally downwardly therefrom such that second spaces are formed between adjacent ribs, the second rim having a generally concave shape,
wherein the first rim and the second rim have shapes that correspond with each other when being releasably lockable to each other, wherein the first container and the second container are adapted to be releasably lockable to each other by fitting the second plurality of downwardly-projecting ribs into respective ones of the first plurality of upwardly-projecting ribs and fitting the first spaces into respective ones of the second spaces.

2. The container assembly of claim 1 wherein the first and second containers are bowls.

3. The container assembly of claim 1 wherein the first and second containers are plates.

4. The container assembly of claim 1 wherein the first container is a bowl and the second container is a plate.

5. The container assembly of claim 1 wherein the first and second containers are made of polymeric material.

6. The container assembly of claim 5 wherein the first and second containers are made of a mineral-filled polymeric material.

7. The container assembly of claim 1 wherein the first plurality of upwardly-projecting ribs comprises first and second sidewalls and a surface that encompasses and bridges the first and second sidewalls, at least one of the first and second sidewalls having a first undercut, and wherein the second plurality of downwardly-projecting ribs comprises third and fourth sidewalls and a surface that encompasses and bridges the third and fourth sidewalls, at least one of the third and fourth sidewalls having a second undercut.

8. The container assembly of claim 1 wherein the first plurality of upwardly-projecting ribs creates a first pattern that is generally normal to the direction of the first rim, and the second plurality of downwardly-projecting ribs creates a second pattern that is generally normal to the direction of the second rim.

9. The container assembly of claim 1 wherein each of the first plurality of upwardly-projecting ribs is generally concentric with the center of the first container and each of the second plurality of downwardly-projecting ribs is generally concentric with the center of the second container.

10. The container assembly of claim 1 wherein each of the first plurality of upwardly-projecting ribs and the second plurality of downwardly-projecting ribs includes at least about 20 ribs.

11. The container assembly of claim 10 wherein each of the first plurality of upwardly-projecting ribs and the second plurality of downwardly-projecting ribs includes at least about 40 ribs.

12. The container assembly of claim 1 wherein the first rim and the second rim are adapted to form a seal.

13. A method of forming a container assembly, the method comprising the acts of:
providing a first container that includes a first continuous body portion and a first rim, the first rim encompassing and projecting laterally outwardly from the first body portion, the first rim having a first plurality of ribs projecting generally upwardly therefrom such that first spaces are formed between adjacent ribs, the first rim having a generally convex shape;
providing a second container that includes a second continuous body portion and a second rim, the second rim encompassing and projecting laterally outwardly from the second body portion, the second rim having a second plurality of ribs projecting generally downwardly therefrom such that second spaces are formed between adjacent ribs, the second rim having a generally concave shape,
flipping one of the first container and the second container such that the first container and second container are generally aligned, the first and second rims are next to each other, and the first and second rims correspond with each other such that the first and second rims are either both in a generally concave orientation or a generally convex orientation; and
fitting the second plurality of downwardly-projecting ribs into respective ones of the first plurality of upwardly-projecting ribs and fitting the first spaces into respective ones of the second spaces such that the first container and the second container are releasably lockable to each other.

14. The method of claim 13 further including placing a food article on at least one of the first container and the second container before fitting the second plurality of downwardly-projecting ribs into respective ones of the first plurality of upwardly-projecting ribs and fitting the first spaces into respective ones of the second spaces.

15. A container assembly comprising:
a first container including a first continuous body portion and a first rim, the first rim encompassing and projecting laterally outwardly from the first body portion, the first rim having a first plurality of upwardly-projecting features with first spaces being formed between adjacent upwardly-projecting features, the first rim having a generally convex shape; and
a second container including a second continuous body portion and a second rim, the second rim encompassing and projecting laterally outwardly from the second body portion, the second rim having a second plurality of downwardly-projecting features with second spaces being formed between adjacent downwardly-projecting features, the second rim having a generally concave shape,
wherein the first container and the second container are adapted to be releasably lockable to each other by fitting the second plurality of downwardly-projecting features into respective ones of the first plurality of upwardly-projecting features and fitting the first spaces into respective ones of the second spaces.

16. The container assembly of claim 15 wherein the first and second containers are made of polymeric material.

17. A container assembly comprising:
a first container including a first continuous body portion and a first rim, the first rim encompassing and projecting laterally outwardly from the first body portion, the first rim having a generally convex shape, the first rim having a first plurality of ribs projecting generally upwardly therefrom such that first spaces are formed between adjacent ribs, the first plurality of upwardly-projecting ribs creating a first pattern that is generally normal to the direction of the first rim, the first plurality of upwardly-projecting ribs having at least one undercut; and
a second container including a second continuous body portion and a second rim, the second rim encompassing and projecting laterally outwardly from the second body portion, the second rim having a generally concave shape, the second rim having a second plurality of ribs projecting generally downwardly therefrom such that second spaces are formed between adjacent ribs, the second plurality of downwardly-projecting ribs creating a second pattern that is generally normal to the direction of the second rim, the second plurality of downwardly-projecting ribs having at least one undercut,
wherein the first container and the second container are adapted to be releasably lockable to each other by fitting the second plurality of downwardly-projecting ribs into respective ones of the first plurality of upwardly-projecting ribs and fitting the first spaces into respective ones of the second spaces.

18. A container assembly comprising:
a first container including a first continuous body portion and a first rim, the first rim encompassing and projecting laterally outwardly from the first body portion, the first rim having a first plurality of ribs projecting generally upwardly therefrom such that first spaces are formed between adjacent ribs, the first plurality of upwardly-projecting ribs creating a first pattern that is generally normal to the direction of the first rim;
a second container including a second continuous body portion and a second rim, the second rim encompassing and projecting laterally outwardly from the second body portion, the second rim having a second plurality of ribs projecting generally downwardly therefrom such that second spaces are formed between adjacent ribs, the second plurality of downwardly-projecting ribs creating a second pattern that is generally normal to the direction of the second rim, the second container being shaped generally the same as the first container,
wherein the first container and the second container are adapted to be releasably lockable to each other by fitting the second plurality of downwardly-projecting ribs into respective ones of the first plurality of upwardly-projecting ribs and fitting the first spaces into respective ones of the second spaces.

19. The container assembly of claim 18 wherein the first and second containers are bowls.

20. The container assembly of claim 18 wherein the first and second containers are plates.

21. The container assembly of claim 18 wherein the first container is a bowl and the second container is a plate.

22. The container assembly of claim 18 wherein the first and second containers are made of polymeric material.

23. The container assembly of claim 22 wherein the first and second containers are made of a mineral-filled polymeric material.

24. The container assembly of claim 18 wherein at least one of the first and second containers is paper or metal.

25. The container assembly of claim 18 wherein the first container is shaped substantially the same as the second container.

26. The container assembly of claim 18 wherein the first plurality of upwardly-projecting ribs and the second plurality of downwardly-projecting ribs are generally square.

27. The container assembly of claim 26 wherein the first plurality of upwardly-projecting ribs and the second plurality of downwardly-projecting ribs are square.

28. The container assembly of claim 18 wherein the first plurality of upwardly-projecting ribs comprises first and second sidewalls and a surface that encompasses and bridges the first and second sidewalls, at least one of the first and second sidewalls having a first undercut, and wherein the second plurality of downwardly-projecting ribs comprises third and fourth sidewalls and a surface that encompasses and bridges the third and fourth sidewalls, at least one of the third and fourth sidewalls having a second undercut.

29. The container assembly of claim 18 wherein the first plurality of upwardly-projecting ribs and the second plurality of downwardly-projecting ribs are generally polygonal.

30. The container assembly of claim 18 wherein each of the first plurality of upwardly-projecting ribs and the second plurality of downwardly-projecting ribs includes at least about 20 ribs.

31. The container assembly of claim 30 wherein each of the first plurality of upwardly-projecting ribs and the second plurality of downwardly-projecting ribs includes at least about 40 ribs.

32. The container assembly of claim 18 wherein the first rim and the s second rim are adapted to form a seal.

33. A method of forming a container assembly, the method comprising the acts of:
providing a first container that includes a first continuous body portion and a first rim, the first rim encompassing and projecting laterally outwardly from the first body portion, the first rim having a first plurality of ribs projecting generally upwardly therefrom such that first spaces are formed between adjacent ribs, the first plurality of upwardly-projecting ribs creating a first pattern that is generally normal to the direction of the first rim;
providing a second container that includes a second continuous body portion and a second rim, the second rim encompassing and projecting laterally outwardly from the second body portion, the second rim having a second plurality of ribs projecting generally downwardly therefrom such that second spaces are formed between adjacent ribs, the second plurality of downwardly-projecting ribs creating a second pattern that is generally normal to the direction of the second rim, the second container being shaped generally the same as the first container;
flipping one of the first container and the second container such that the first container and second container are generally aligned, and the first and second rims are next to each other; and
fitting the second plurality of downwardly-projecting ribs into respective ones of the first plurality of upwardly-projecting ribs and fitting the first spaces into respective ones of the second spaces such that the first container and the second container are releasably lockable to each other.

34. The method of claim 33 further including placing a food article on at least one of the first container and the second container before fitting the second plurality of downwardly-projecting ribs into respective ones of the first plurality of upwardly-projecting ribs and fitting the first spaces into respective ones of the second spaces.

35. A container assembly comprising:
a first container including a first continuous body portion and a first rim, the first rim encompassing and projecting laterally outwardly from the first body portion, the first rim having a first plurality of upwardly-projecting features with first spaces being formed between adjacent upwardly-projecting features, the first plurality of upwardly-projecting features creating a first pattern that is generally normal to the direction of the first rim; and
a second container including a second continuous body portion and a second rim, the second rim encompassing and projecting laterally outwardly from the second body portion, the second rim having a second plurality of downwardly-projecting features with second spaces being formed between adjacent downwardly-projecting features, the second plurality of downwardly-projecting features creating a second pattern that is generally normal to the direction of the second rim, the second container being shaped generally the same as the first container;
wherein the first container and the second container are adapted to be releasably lockable to each other by fitting the second plurality of downwardly-projecting features into respective ones of the first plurality of upwardly-projecting features and fitting the first spaces into respective ones of the second spaces.

36. The container assembly of claim 35 wherein the first and second containers are made of polymeric material.
